(19) United States
(12) Patent Application Publication
(10) Pub. No.: US 2017/0038859 A1
(43) Pub. Date: Feb. 9, 2017

(54) WATCH INCLUDING TOUCH SENSOR

(71) Applicant: Samsung Display Co., Ltd., Yongin-si (KR)

(72) Inventors: Na Ri PARK, Incheon (KR); Ju-Bong AN, Asan-si (KR); Hyun-Uk OH, Seongnam-si (KR); Yeon-Shil JUNG, Cheonan-si (KR)

(21) Appl. No.: 15/098,160

(22) Filed: Apr. 13, 2016

(30) Foreign Application Priority Data
Aug. 3, 2015 (KR) 10-2015-0109553

(51) Int. Cl. G06F 3/041; G06F 3/01; G06F 1/16

(52) U.S. Cl. CPC G06F 3/041; G06F 1/163; G06F 3/017

(57) ABSTRACT

A watch may include a display, a bezel, and a controller. The bezel may be positioned at a periphery of the display and may include a bezel touch sensor set. The bezel touch sensor set may receive a first touch without moving with respect to any other part of the bezel and may generate first touch information in response to the first touch. The controller may be electrically connected to each of the bezel touch sensor set and the display and may use the first touch information to generate a first control signal for controlling the display.

### CROSS-REFERENCE TO RELATED APPLICATION

This application claims priority to and the benefit of Korean Patent Application No. 10-2015-0109553, filed in the Korean Intellectual Property Office on Aug. 3, 2015; the entire contents of the Korean Patent Application are incorporated herein by reference.

### BACKGROUND

(a) Technical Field

The technical field relates to a watch (e.g., a smartwatch) that includes a touch sensor.

(b) Description of the Related Art

A watch, e.g., a smartwatch, may include a display portion for displaying information such as time, date, messages, and contents as images. The display portion may have a touch sensor function to interact with a user. However, the display portion may be substantially small, such that performing touch operations on the display portion may be substantially difficult and/or inconvenient.

The above information disclosed in this Background section is for enhancing understanding of the background of this application. The Background section may contain information that does not form the prior art that is already known in this country to a person of ordinary skill in the art.

### SUMMARY

Embodiments may be related to a watch, e.g., a smartwatch, with a convenient and/or intuitive touch user interface.

An embodiment may be related to a watch. The watch may include a display, a bezel, and a controller. The bezel may be positioned at a periphery of the display and may include a bezel touch sensor set. The bezel touch sensor set may receive a first touch without moving with respect to any other part of the bezel and may generate first touch information in response to the first touch. The controller may be electrically connected to each of the bezel touch sensor set and the display and may use the first touch information to generate a first control signal for controlling the display.

The first touch information may include at least one of touch sensor identification information and touch position information.

The watch may include a band. The band may be connected to the bezel and may be configured for joining the bezel to a user of watch. The first touch may be received through a surface of the bezel. The band may cross or directly contact the surface of the bezel.

The first touch may be a sliding touch performed along a surface of the bezel for a distance. The sliding touch may have a nonlinear path (e.g., a curved path).

The bezel touch sensor set may include a plurality of touch sensors. A first touch sensor of the touch sensors may be activated by at least one of a first condition, a second condition, a third condition, and a fourth condition. The first condition may include that any two touch sensors of the touch sensors receive separate touches for a predetermined time length. The second condition may include that two predetermined touch sensors of the touch sensors receive respective touches for a predetermined time duration. The third condition may include that a touch sensor of the touch sensors receives two touches within a predetermined time period. The fourth condition may include that a button positioned at the bezel is pressed.

The bezel touch sensor set may include a plurality of touch sensors. The touch sensors may be distributed between two nonlinear boundaries of the bezel in a plan view of the bezel.

The display may display a first image when the bezel touch sensor set receives a counterclockwise slide touch. The display may display a second image when the bezel touch sensor set receives a clockwise slide touch.

The bezel touch sensor set may include a first touch sensor and a second touch sensor. The second touch sensor may be positioned closer to a screen of the display than the first touch sensor.

The bezel touch sensor set may include a plurality of touch sensors. The touch sensors may be distributed in a direction that is perpendicular to a screen of the display.

The display may be display a first image when the bezel touch sensor set receives a slide touch toward a screen of the display. The display may display a second image when the bezel touch sensor set receives a continuous touch away from the screen of the display.

The bezel touch sensor set may include a plurality of touch sensors. The touch sensors may surround the display in a plan view of a combination of the bezel and the display.

The bezel touch sensor set may include a plurality of touch sensors. Two geometric lines that respectively connect two immediately neighboring touch sensors of the touch sensors to a center of the display may form a 30-degree angle in a plan view of a combination of the bezel and the display.

The bezel touch sensor set may include a plurality of touch sensors. Geometric lines that connect opposite touch sensors of the touch sensors may overlap diameters of the display in a plan view of a combination of the bezel and the display.

The bezel touch sensor set may include twelve touch sensors that respectively correspond to twelve hours.

The bezel touch sensor set may include a first touch sensor and a second touch sensor. The display may include a display touch sensor set. The first touch sensor may be mapped to a predetermined hour among twelve hours. The display may be configured to display schedule information associated with the predetermined hour in response to a schedule display condition. The schedule display condition may include that the first touch sensor receives an end touch after at least one of the second touch sensor and the display touch sensor set have received a start touch.

The bezel touch sensor set may include a plurality of touch sensors. A geometric line that connects two touch sensors of the touch sensors may be configured to be a reference line. The display may display images according to movement directions of slide touches received by one or more of the touch sensors with reference to the reference line.

The watch may include a gravity sensor. The gravity sensor may be connected to the controller and may provide orientation information based on an orientation of the display. The controller may use the orientation information to generate a second control signal for controlling the display to turn off or to turn on.

The gravity sensor may be positioned inside the bezel.

An embodiment may be related to a watch. The watch may include a display, a bezel, and a controller. The bezel may be positioned at a periphery of the display and may include a bezel touch sensor set. The bezel touch sensor set may be configured to receive a first touch and may be configured to generate first touch information in response to the first touch. The first touch information may include at least one of touch sensor identification information and touch position information. The controller may be electrically connected to each of the bezel touch sensor set and the display and may use the first touch information to generate a first control signal for controlling the display to display a first image.

A watch, e.g., a smartwatch, according to an embodiment includes a display portion and a bezel portion. The bezel portion may be located at a periphery of the display portion and may include a bezel touch sensor set, which may be associated with a touch sensing area. The smartwatch performs an operation corresponding to a touch event including touches at a first point and a second point, and at least one of the first point and the second point is in the touch sensing area of the bezel portion.

The first point and second point may both be in the touch sensing area of the bezel portion.

The touch event may be a slide touch that continuously moves from the first point to the second point.

The touch event may cause the display portion to perform any one of the following operations: displaying an enlarged image, displaying a reduced image, displaying a previous image, and displaying a next image. The first point and the second point may correspond to the same point of the touch sensing area of the bezel portion.

An object or a command to be displayed on the display portion may be selected by the touch event.

The first point and the second point may correspond to two different points of the touch sensing area of the bezel portion.

The smartwatch may include a touch sensor positioned in the bezel portion, and the touch sensor may be activated by the touch event.

The touch event may be a moving touch where a touch starts at the first point and ends at the second point.

The second point may be in the touch sensing area of the bezel portion, and a schedule check operation for a time corresponding to the second point may be performed by the touch event.

The touch event may further include a touch at a third point that is in the touch sensing area of the bezel portion.

The first point and the third point may be located in the touch sensing area of the bezel portion that is positioned below or above a reference line extending in a first direction of the display portion, and the second point may be in the touch sensing area of the bezel portion that is positioned above or below the reference line of the display portion.

The touch event may further include a touch at a fourth point that is in the touch sensing area of the bezel portion.

The touch sensing area of the bezel portion may be discretely/separately positioned such that touches at positions corresponding to hour indexes are respectively sensed.

A specific application may be executed when a specific position of the touch sensing area of the bezel portion is touched.

The smartwatch may further include a gravity sensor, and the smartwatch may be operated to rotate or turn on/off a screen displayed on the display portion based on an output signal of the gravity sensor. The gravity sensor may include a weight and a hole through which the weight moves.

The display portion may include a touch sensing area.

According to an embodiment, the total touch area of the watch can be maximized to implement a convenient, easy, and/or intuitive touch user interface.

### BRIEF DESCRIPTION OF THE DRAWINGS

FIG. 1 schematically illustrates a watch, e.g., a smartwatch, according to an embodiment.

FIG. 2 is a block diagram illustrating elements in a watch, e.g., a smartwatch, according to an embodiment.

FIG. 3, FIG. 4, FIG. 5, FIG. 6, FIG. 7, FIG. 8, FIG. 9, FIG. 10, and FIG. 11 schematically illustrate one or more watches and related operations according to some embodiments.

FIG. 12, FIG. 13, and FIG. 14 illustrate a watch, e.g., a smartwatch, with a gravity sensor according to an embodiment.

FIG. 15 is a block diagram illustrating elements in a watch, e.g., a smartwatch, according to an embodiment.

### DETAILED DESCRIPTION OF EMBODIMENTS

Embodiments are described with reference to the accompanying drawings. As those skilled in the art would realize, the described embodiments may be modified in various different ways.

Although the terms “first”, “second”, etc. may be used herein to describe various elements, these elements should not be limited by these terms. These terms may be used to distinguish one element from another element. Thus, a first element recited in this application may be termed a second element without departing from embodiments. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

If a first element (such as a layer, film, region, or substrate) is referred to as being “on”, “neighboring”, “connected to”, or “coupled with” a second element, then the first element can be directly on, directly neighboring, directly connected to, or directly coupled with the second element, or an intervening element may also be present between the first element and the second element. If a first element is referred to as being “directly on”, “directly neighboring”, “directly connected to”, or “directed coupled with” a second element, then no intended intervening element (except environmental elements such as air) may be provided between the first element and the second element.

Spatially relative terms, such as “beneath”, “below”, “lower”, “above”, “upper”, and the like, may be used herein for ease of description to describe one element or feature's spatial relationship to another element(s) or feature(s) as illustrated in the figures. It will be understood that the spatially relative terms may encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein should be interpreted accordingly.

The terminology used herein is for the purpose of describing particular embodiments and is not intended to limit the embodiments. As used herein, the singular forms, “a”, “an”, and “the” may indicate plural forms as well, unless the context clearly indicates otherwise. The terms “includes” and/or “including”, when used in this specification, may specify the presence of stated features, integers, steps, operations, elements, and/or components, but may not preclude the presence or addition of one or more other features, integers, steps, operations, elements, components, and/or groups.

Unless otherwise defined, terms (including technical and scientific terms) used herein have the same meanings as commonly understood by one of ordinary skill in the art. Terms, such as those defined in commonly used dictionaries, should be interpreted as having meanings that are consistent with their meanings in the context of the relevant art and should not be interpreted in an idealized or overly formal sense unless expressly so defined herein.

The term “connect” may mean “directly connect”, “indirectly connect”, or “electrically connect”. The term “insulate” may mean “electrically insulate”. The term “conductive” may mean “electrically conductive”. The term “electrically connected” may mean “electrically connected without any intervening transistors” or “electrically connected through no intervening transistors”.

Although watches, e.g., smartwatches, are described as examples, embodiments may be applicable to other mobile devices, wearable devices, and the like.

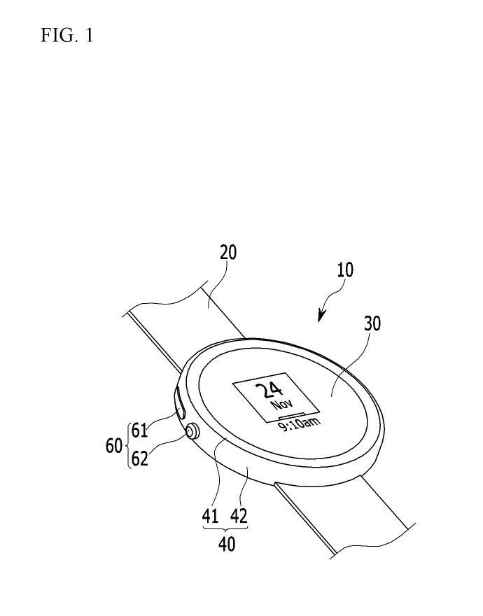

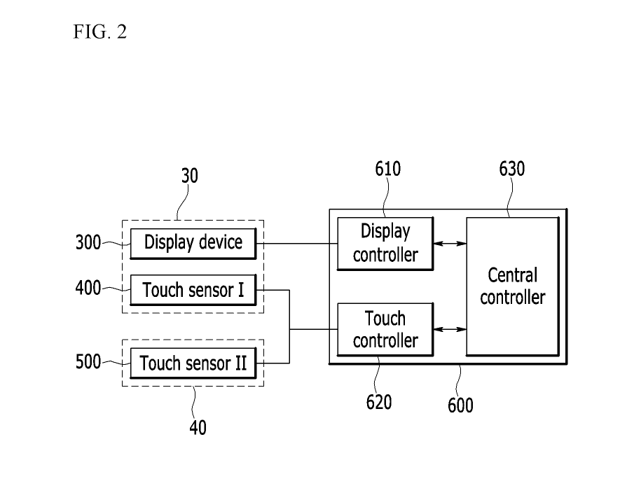

FIG. 1 schematically illustrates a watch, e.g., a smartwatch, according to an embodiment, and FIG. 2 is a block diagram illustrating elements in the watch according to an embodiment. Referring to FIG. 1, the smartwatch includes a body 10 and a band 20. The body 10 includes a display portion 30 where an image is displayed, and a bezel portion 40 surrounding the display portion 30. The band 20, which is partially illustrated, is provided to join the body 10 to a body part of a user, e.g., to allow the body 10 to be positioned, tied, and/or secured on a user's wrist and may be/include, for example, a strap, a chain, or a bracelet.

The display portion 30 may be configured to display images that represent information, contents, and user interfaces, and may be positioned at a substantial center of a top surface of the body 10. For image display, the smartwatch may include a display device 300, such as an organic light emitting diode (OLED) display device or a liquid crystal display (LCD) device. In the display device 300, a screen on which an image is displayed (display area) may be positioned in the display portion 30, while a peripheral area of the screen (non-display area) may be positioned in the bezel portion 40. The display portion 30 may substantially have a circular shape, as illustrated, but it is not limited thereto and may have one or more of various shapes, e.g., a polygonal shape such as a quadrangular shape or an oval shape. The display portion 30 may be positioned at a region that corresponds to a region of a dial or a digital display of an ordinary watch.

The display portion 30 includes a touch sensing function for interaction with a user, in addition to an image display function. The touch sensing function is used to obtain touch information, such as whether an object touches a screen or not, a touch position, and the like by sensing a change in pressure, charges, light, and the like that are applied to a screen of a display device when a user touches the screen with a finger or a touch pen. The display device 300 may receive an image signal based on such touch information. In this case, a touch may include at least one of a contact type of touch (in which an object directly contacts the screen) and a contactless type of touch (in which an object hovers over or approaches the screen).

For the touch sensing function, a display touch sensor set 400 (or touch sensor 400 for conciseness) is formed in the display portion 30. The touch sensor 400 may be or may include, for example, at least one of a capacitive type touch sensor, a resistive type touch sensor, an electro-magnetic type touch sensor, and an optical type touch sensor. Two or more types of touch sensors 400 may be formed in the display portion 30. The touch sensor 400 may be formed in the display device 300 or may be attached thereto, and the display portion 30 may correspond to a touch screen. A touch sensing area in which the touch is sensed by the touch sensor 400 may be formed.

The bezel portion 40 may function as a frame or rim that surrounds, secures, and/or supports the display portion 30. The bezel portion 40 may have a substantially circular ring shape when the display portion 30 has a circular shape, and the bezel portion 40 may have a substantially quadrangular ring shape when the display portion 30 has a quadrangular shape, but it is not limited thereto, and it may have a suitable shape that corresponds to the shape of the display portion 30. The bezel portion 40 corresponds to a part of the top surface of the body 10, and may include a top surface portion 41 disposed on substantially the same plane as the display portion 30 and a lateral surface portion 42 corresponding to an edge of the body 10. However, depending on what shape the body 10 has, the top surface portion 41 and the lateral surface portion 42 may not be clearly distinguished from each other, and for example, the top surface portion 41 and the lateral surface portion 42 may form a curved surface without having a sharp border between portions 41 and 42.

The bezel portion 40 includes the touch sensing function that enables interaction with a user. For the touch sensing function, a bezel touch sensor set 500 (or touch sensor 500 for conciseness) is formed in the bezel portion 40. The touch sensor 500 may be or include, for example, at least one of a capacitive type touch sensor, a resistive type touch sensor, an electro-magnetic type touch sensor, and an optical type touch sensor. Two or more types of touch sensors 500 may be formed in the bezel portion 40.

The touch sensor 500 may be formed such that the entire bezel portion 40 may substantially be a touch sensing area. The touch sensor 500 may be formed such that only a part of the bezel portion 40 is a touch sensing area, for example, only the top surface portion 41 or the lateral surface portion 42. Even if only the lateral surface portion 42 of the bezel portion 40 is the touch sensing area, the touch sensing area may be expanded (beyond the area of the display portion 30) by about 2πrt (herein, π is pi) if the body 10, for example, has a cylindrical shape with a radius r and a thickness t. Hereinafter, unless specifically mentioned, an example in which the touch sensing area is not separately formed in the top surface portion 41 and the lateral surface portion 42, but is formed in the entire bezel portion 40, will be described. In an embodiment, the touch sensing area is formed in the entire bezel portion 40, and the touch sensing area may be substantially continuous (e.g., all regions of the bezel portion 40 are touch sensing areas). In an embodiment, discrete touch sensing areas of the bezel portion 40 may be discontinuously positioned with interposing intervals.

As described above, in the smartwatch according to an embodiment, a touch sensing area is formed in the display portion 30, and a touch sensing area is formed in the bezel portion 40. Accordingly, the total touch sensing area of the smartwatch is not only present in the display portion 30, but is also present in the bezel portion 40. That is, the total touch sensing area is expanded to the bezel portion 40. In some embodiments, only the bezel portion 40 may include the touch sensor 500, while the display portion 30 may not include any touch sensor.

The smartwatch may include an input means 60 for interaction with a user, in addition to the touch sensors 400 and 500. The input means 60 may be disposed in the bezel portion 40 of the body 10. The input means 60 may include a button type of input means 61, and a rotational type of input means 62, such as a crown of an ordinary wristwatch.

The smartwatch includes a control device 600 for controlling various kinds of operations of the smartwatch, and the control device 600 may be positioned inside the body 10 as an integrated circuit (IC) or the like. The control device 600 controls operations of the display device 300, the touch sensors 400 and 500, and the like. The control device 600 controls the operation of the display device 300 by receiving an image signal and a related control signal and processing the image signal in accordance with operating conditions of the display device to output a processed image signal. The control device 600 transmits a driving signal to the touch sensors 400 and 500 if necessary, and may generate touch information, such as whether a touch occurs or not, a touch position, and a type of touch, by receiving the output signal from the touch sensors 400 and 500. The control device 600 determines a user command based on the touch information, and may control the operation of the display device 300 in response to the user command.

The control device 600 may include a display controller 610 for controlling the display device 300 and a touch controller 620 for controlling the touch sensors 400 and 500, and may include a central controller 630 for controlling operations of the display controller 610 and the touch controller 620. In this case, the display controller 610 may control the operation of the display device 300 by receiving an image signal and a related control signal, and processing the image signal in accordance with operating conditions of the display device to output a processed image signal. The touch controller 620 may generate touch information, such as whether a touch occurs or not, a touch position, and a type of touch by transmitting a driving signal to the touch sensors 400 and 500 and then receiving output signals from the touch sensors 400 and 500. The touch controller 620 may activate or deactivate the touch sensor 400 and/or the touch sensor 500. The central controller 630 may control the display controller 610 such that a necessary display operation is performed based on the touch information, and may provide a synchronization signal to the touch controller 620. The touch information and the synchronization signal may be transmitted between the display controller 610 and the touch controller 620, even without involving the central controller 630.

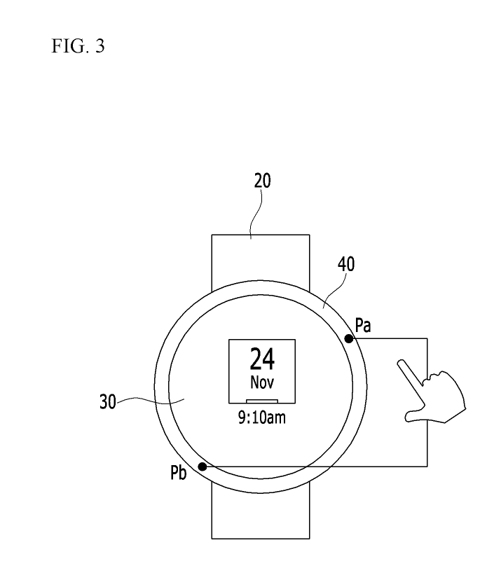

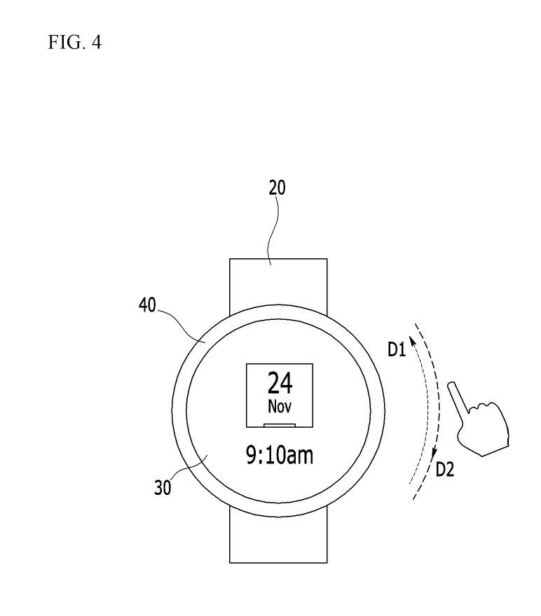

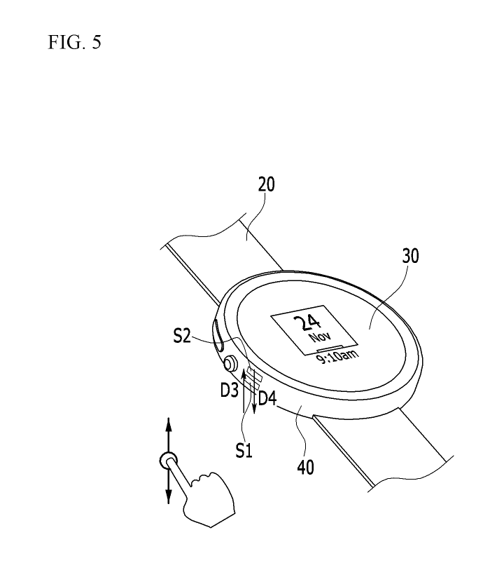

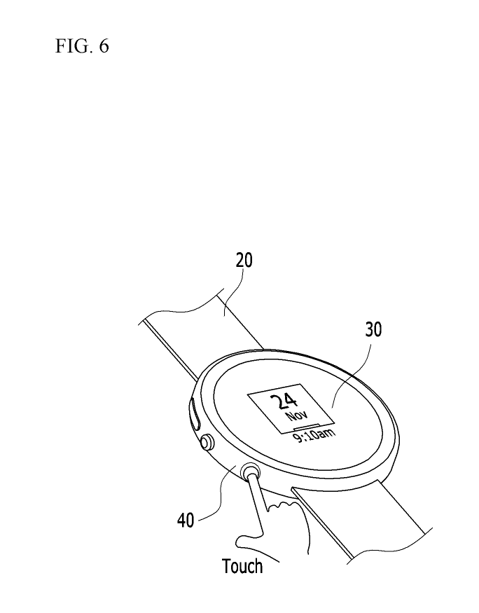

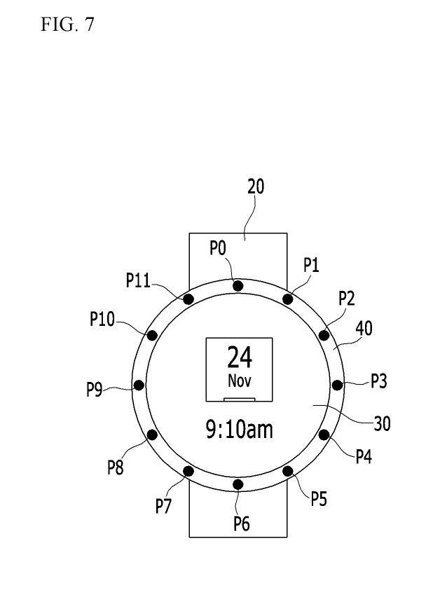

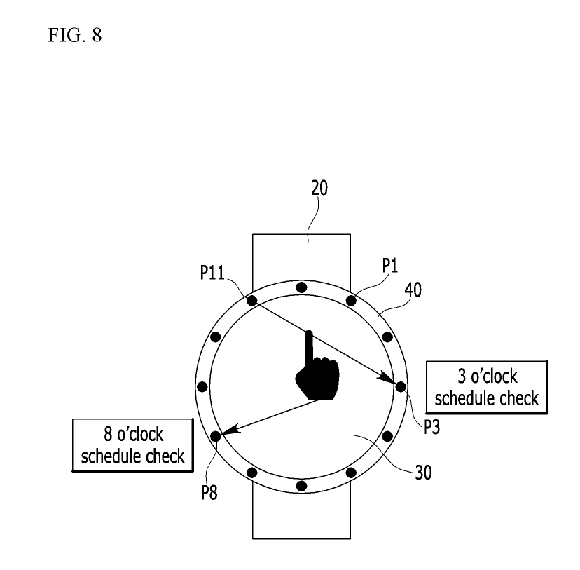

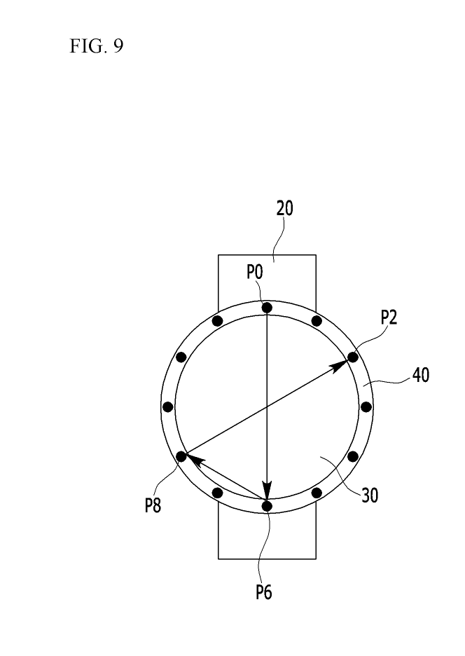

FIGS. 3 to 11 schematically illustrate one or more watches and related operations according to some embodiments.

First, referring to FIG. 3, along with FIGS. 1 and 2, a touch sensor 500 (i.e., bezel touch sensor set 500) formed in a bezel portion 40 may be activated in response to a user's touch. As the touch sensor 500 is activated, a touch sensing area of the bezel portion 40, i.e., one or more touch sensors of the touch sensor 500, may also be activated to sense various touch events. Since the user's body or an object nearby may easily contact the bezel portion 40, an undesired operation may be performed if the touch sensor 500 of the bezel portion 40 is always activated. Accordingly, the touch sensor 500 of the bezel portion 40 should be activated only if at least a predetermined condition is met.

To activate the touch sensor 500, the touch sensor 500 may be set to be activated when a plurality of points of the bezel portion 40, e.g., two points Pa and Pb, are touched for a predetermined time. The two points Pa and Pb may represent two random or predetermined touch sensors of the touch sensor 500 (i.e., touch sensor set 500) and may be random or predetermined points within the touch sensing area of the bezel portion 40. In some embodiments, the touch sensor 500 may be set to be activated when one point of the bezel portion 40 is consecutively touched more than two times within a predetermined time period. In some embodiments, the touch sensor 500 may be set to be activated by manipulating the input means 60, e.g., by pressing a button type of input means 61. When no touch event occurs for a predetermined time after the touch sensor 500 is activated, the touch sensor 500 may be set to be deactivated.

When a touch event including a touch on the touch sensing area of the bezel portion 40 occurs after the touch sensor 500 is activated, the control device 600 determines a user command by determining a kind of touch event corresponding to a user input. Depending on the determined user command, the control device 600 may control the smartwatch, particularly the display device 300, in order to perform a specific operation. Which specific touch events correspond to which specific user commands may be preconfigured and may be stored in a system memory. Such a correspondence may be intuitively perceived and easily remembered by the user depending on the kinds of touch events. Such a correspondence may be configured to be unchangeable, but may be, for example, configured to be changed by the user's needs via a configuration menu provided in the watch or in a smartphone.

Referring to FIGS. 4 and 5, a case in which a touch event is a slide touch on the touch sensing area of the bezel portion 40 is illustrated. In this case, the slide touch event may represent a touch that continuously moves for a distance from one point of the touch sensing area to another point while maintaining the touch. The user command for the touch event may be configured such that it is interpreted differently depending on a slide direction of the slide touch. In an embodiment, the slide touch may have a nonlinear path, e.g., a curved path, along a curved surface of the bezel portion 40.

The bezel touch sensor set 500 may include touch sensors distributed between two nonlinear boundaries (e.g., two curved boundaries) of the bezel 40 in a plan view of the bezel 40. For example, as shown in FIG. 4, when the slide direction is a counterclockwise direction D1, the touch event may correspond to a command for displaying an enlarged image within the screen. When the slide direction is a clockwise direction D2, the touch event may correspond to a command for displaying a reduced image within the screen. Accordingly, the image within the screen of the display portion 30 may be enlarged when the slide touch event in the counterclockwise direction D1 occurs, and the image within the screen may be reduced when the slide touch event in the clockwise direction D2 occurs.

The bezel touch sensor set 500 may include a first touch sensor 51 and a second touch sensor S2. The second touch sensor S2 may be positioned closer to the screen of the display 30 than the first touch sensor 51. The bezel touch sensor set 500 may include touch sensors distributed and aligned in a direction perpendicular to the screen of the display 30. As shown in FIG. 5, when the slide direction is a direction D3 from a bottom surface of the body 10 to a top surface thereof, the touch event corresponds to a command for displaying the previous image or a page-up command, and when the slide direction is a direction D4 from the top surface of the body 10 to the bottom surface thereof, the touch event may correspond to a command for displaying the next image or a page-down command.

Referring to FIG. 6, an example in which a touch event is a repeated touch for one point of the bezel portion 40 (i.e., one touch sensor of the bezel touch sensor set 500) is illustrated. Consecutively touching the one point of the touch sensing area of the bezel portion 40 two times may correspond, for example, to a command for selecting an object, command, or the like that is displayed on the screen. Various commands may be configured by changing an interval between the continuous touches, the touch time, and the number of touches. For example, a touch event of three short consecutive touches may be set to make a phone call to a specific person. The point that is consecutively touched may be an arbitrary or predetermined section within the touch sensing area.

Referring to FIGS. 7 to 11, examples in which one or more user commands are executed according to one or more touch events for one or more specific positions of the touch sensing area of the bezel portion 40, i.e., one or more touch sensors of the bezel touch sensor set 500, are illustrated.

Referring to FIG. 1 and FIG. 7, the bezel touch sensor set 500 of the bezel portion 40 may include at least twelve sensors P0, P1, P2, P3, P4, P5, P6, P7, P8, P9, P10, and P11 respectively positioned at and corresponding to twelve hour indexes when the display 30 of watch displays an analog watch layout. The touch sensors P0 to P11 may respectively correspond to twelve hours. The touch sensors P0 to P11 may be positioned between two nonlinear boundaries (e.g., curved and/or circular boundaries) of the bezel 40 in a plan view of the bezel 40. The touch sensors P0 to P11 may surround the display 30 in a plan view of the body 10. A geometric line connecting the touch sensor P1 and the center of the display 30 may be oriented at 30-degree angle with respect to a geometric line connecting the touch sensor P0 (which immediately neighbors the sensor P0 without intervening bezel touch sensors) and the center of the display 30 and with respect to an extension direction of the band 20 in a plan view of the body 10. Two geometric lines that respectively connect every two immediately neighboring touch sensors of the touch sensors P0 to P11 to the center of the display 30 may form a 30-degree angle in a plan view of a combination of the bezel 40 and the display 30. Geometric lines connecting opposite touch sensors of the touch sensors P0 to P11 (e.g., P0 and P6, P1 and P7, P2 and P8, etc.) may overlap diameters of the display 30 in a plan view of a combination of the bezel 40 and the display 30. Touch sensing areas based on the touch sensors P0 to P11 may be discretely positioned in the bezel portion 40 and spaced from each other. One or more of the touch sensors P0 to P11 may receive one or more touches, and the bezel touch sensor set 500 may generate touch information in response to the one or more touches. The touch information may include touch sensor identification information (e.g., one or more of P0 to P11) associated with the touch sensor(s) that receive the touch(es) and/or may include touch position information (e.g., one or more of locations 1 to 12) associated with position(s) of the touch sensor(s) that receive the touch(es). In some embodiments, user commands for the touch events according to touch positions and directions may be intuitively set, and some examples are illustrated in FIGS. 8 to 11.

Referring to FIG. 8, an example in which a user command for checking a specific time schedule is executed by a moving touch event is illustrated. Herein, the moving touch event refers to a touch that starts at one point of the touch sensing area and ends at the other point of the touch sensing area. During the moving touch event, a region between a touch starting point and a touch ending point may be touched or may not be touched, and the region between the two points may not be the touch sensing area.

The moving touch event progressing from a random position in a time direction toward which a schedule is desired to be checked may correspond to a command for checking the schedule of the corresponding time. The random position may be either one of any single point of the bezel portion 40 or any single point of the display portion 30. For example, when wanting to check a 3 o'clock schedule, a user may make a moving touch with a finger or the like that starts at a random point of the display portion 30 (i.e., a touch sensor of the display touch sensor set 400) or the bezel portion 40 (i.e., a touch sensor of the bezel touch sensor set 500) and moves to a 3 o'clock position corresponding to the touch sensor P3 of the bezel portion 40, the touch may be interpreted as a user command for displaying the 3 o'clock schedule, and the 3 o'clock schedule may be displayed on the screen of the display portion 30. Likewise, when wanting to check an 8 o'clock schedule, the user may make a moving touch that starts at a random point of the display portion 30 or the bezel portion 40 and moves to an 8 o'clock position corresponding to the touch sensor P8, and the 8 o'clock schedule may be displayed on the screen of the display portion 30.

Since the desired user command can be executed by only touching in the time direction toward which the schedule is to be checked as if drawing a line, the touch user interface using the touch sensor 500 of the bezel portion 40 and the touch sensing area as described above is very intuitive and simple. Since the moving touch may be made for the display portion 30, the touch sensor 400 and the touch sensing area of the display portion 30 may also be used to sense the moving touch event.

Referring to FIGS. 9 and 10, an example in which a command is executed by a touch pattern event is illustrated. Referring to FIG. 9, as if drawing a certain pattern, for example, a touch event, which starts at a 0 o'clock position corresponding to the touch sensor P0 and moves to a 2 o'clock position corresponding to the touch sensor P2 via a 6 o'clock position corresponding to the touch sensor P6 and a 8 o'clock position corresponding to the touch sensor P8, may correspond to a command for locking the screen of the display portion 30. In this case, even when the user touches the screen of the display portion 30, the screen does not respond to the touch. On the contrary, such a touch pattern event may correspond to a command for deactivating the screen lock. Patterns formed by the touch passing through a plurality of points of the bezel portion 40 may be variously configured, thus various commands may be configured according to kinds of patterns. In particular, since a touch pattern can be made as complex as possible, such that only a specific user may know the pattern, it may be useful for the user to configure and execute the desired specific touch pattern via a predetermined menu of the smartwatch. For example, the specific touch pattern configured by the user may serve as a security key. The touch pattern event may be a moving touch in which a touch is made while continuously moving in the bezel portion 40 and in the display portion 30.

Referring to FIG. 10, a mountain-shaped touch pattern event is illustrated. The mountain-shaped touch pattern may be, for example, a touch that starts at an 8 o'clock position corresponding to the touch sensor P8 and moves to a 4 o'clock position corresponding to the touch sensor P4 via a 0 o'clock position corresponding to the touch sensor P0, and may correspond to a command for returning to a home screen. That is, when the user wants to return to the home screen while using the smartwatch, making the mountain-shaped touch pattern, which is a very simple operation, may be configured to move to the home screen.

A geometric line that connects two touch sensors of the touch sensors P0 to P11 may be configured to be a reference line. The display 30 may display images according to paths or movement directions of slide touches received by one or more of the touch sensors P0 to P11 with reference to the reference line. The mountain-shaped touch pattern may be, for example, a touch that starts at one position of the bezel portion 40 under a reference line corresponding to a substantially horizontal center line of the display portion 30, passes thorough one position of the bezel portion 40 over the reference line, and again terminates at one position of the bezel portion 40 under the reference line. Even though the patterns are similar, it is possible to configure various and intuitive touch user interfaces while changing a position and a direction of the reference line. For example, the reference line is set to correspond to a substantially vertical center line of the display portion 30, and a touch event, which starts at one position of the bezel portion 40 to the right of the reference line, passes through one position of the bezel portion 40 to the left of the reference line, and again terminates at one position of the bezel portion 40 to the left of the reference line, corresponds to a command for displaying the previous image or a page up command, while a touch event in an opposite direction may be set to correspond to a command for displaying the next image or a page down command.

Referring to FIG. 11, the touch sensor 500 of the smartwatch according to the current embodiment may be employed to execute specific applications when the specific positions P0 to P11 of the bezel portion 40 are touched. For example, it may be configured such that a phone app is executed when the 1 o'clock position P1 is touched, a text message app is executed when the 3 o'clock position P3 is touched, a messenger app such as KakaoTalk™ is executed when the 9 o'clock position P9 is touched, and an alarm app is executed when 10 o'clock position P10 is touched. To differentiate from the other touch events, the specific applications described above may be configured to execute by touching the specific positions for more than a predetermined time (e.g., one second). In order for the user to personalize/customize correspondence of the specific application to the specific position, the smartwatch may include a function that provides such correspondence via a predetermined menu.

Hereinafter, a smartwatch with a gravity sensor according to an embodiment and an operation thereof will be described.

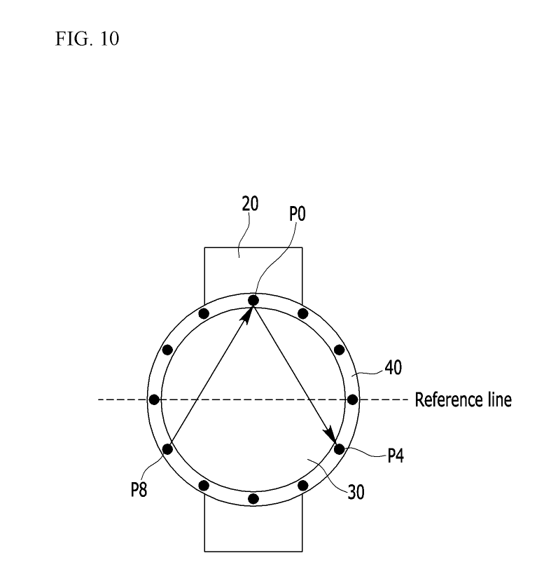

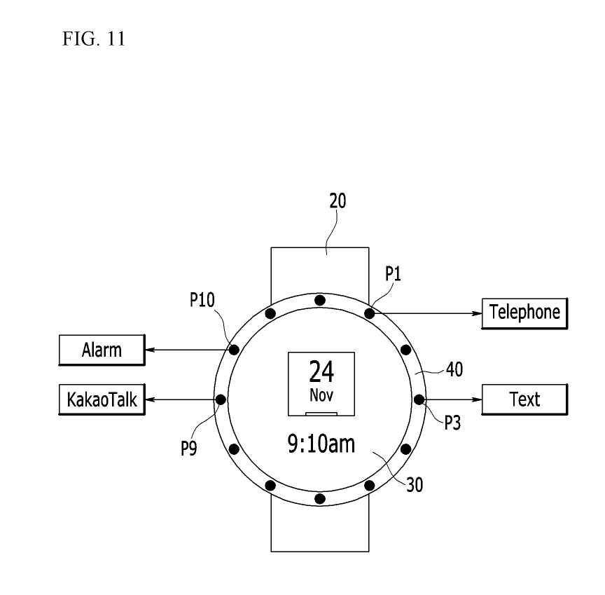

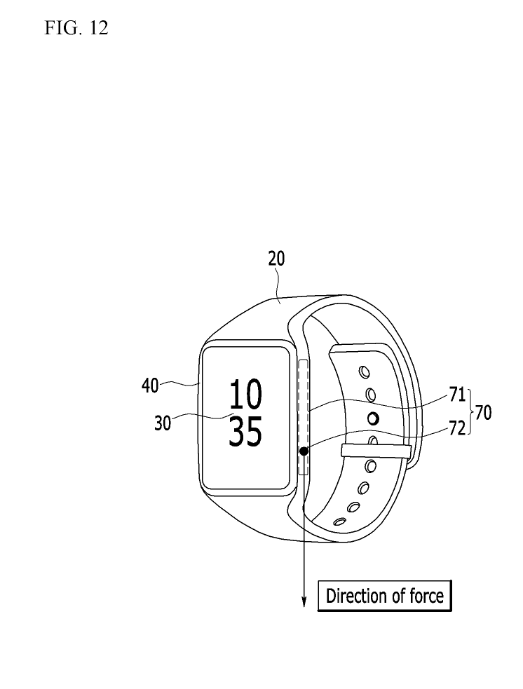

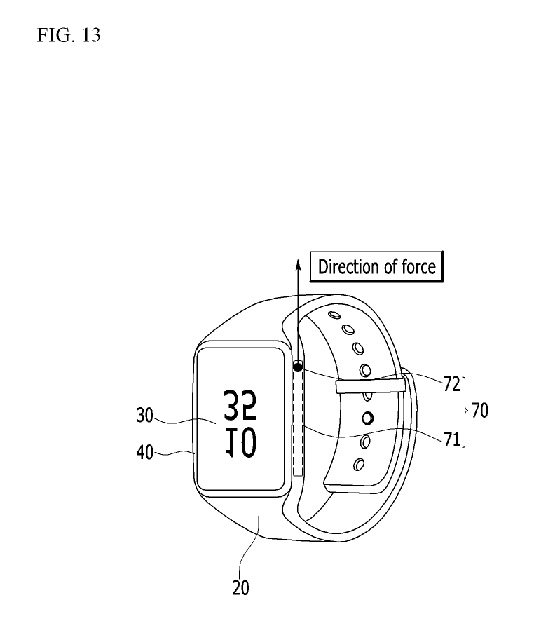

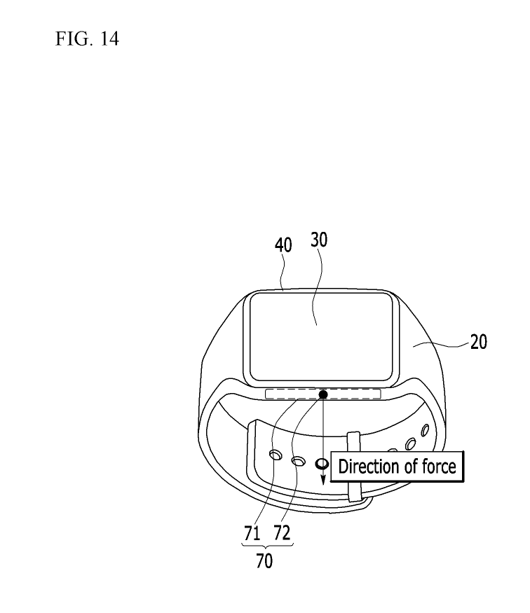

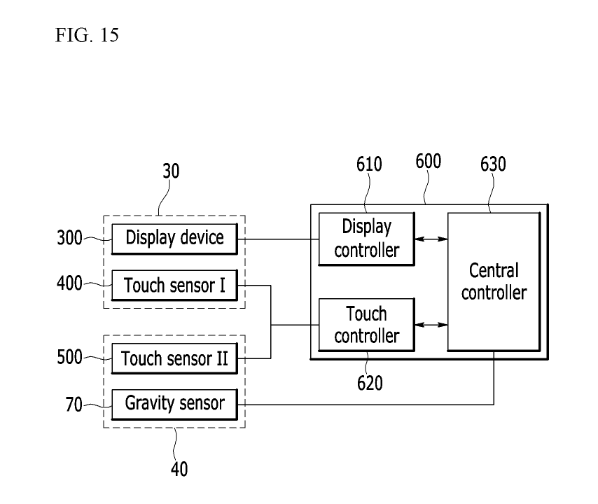

FIGS. 12 to 14 illustrate a watch, e.g., a smartwatch, with a gravity sensor according to an embodiment, and FIG. 15 is a block diagram illustrating a relationship between a display device and a touch sensor and a gravity sensor in the smartwatch according to an embodiment.

Referring to FIGS. 12 to 15, the smartwatch includes a gravity sensor 70. The gravity sensor 70 includes a weight 72 and a hole 71 (i.e., a cavity or channel) in which the weight can move. The gravity sensor 70 is positioned in a bezel portion 40 of a body 10, and may be additionally formed in the bezel portion 40 of one or more of the watches described above with reference to FIGS. 1 to 11, where a touch sensor 500 is formed. In some embodiments, the gravity sensor 70 may be positioned in a region other than the bezel portion 40, for example, inside the body 10. The gravity sensor 70 may provide orientation information related to orientations of the body 10. The controller 600 may use the orientation information to generate a second control signal for controlling the display to turn off, to turn on, or to display a certain image.

The weight 72 of the gravity sensor 70 may move in a direction toward which gravity works in a space defined by the hole 71. Accordingly, if a position of the weight 72 is identified, how the smartwatch is positioned/oriented, particularly how the body 10 is positioned/oriented, may be identified. The gravity sensor 70 transmits an output signal according to the position of the weight 72 to a central controller 630, and the central controller 630 may determine the position of the body 10 based on the output signal and control the display controller 610 to rotate the screen of the display portion 30 or turn it on or off. In some embodiments, the smartwatch may include an additional gravity sensor controller (not shown) for controlling the gravity sensor 70 and signal processing, and the gravity sensor controller may transmit position information of the body 10 obtained from the gravity sensor 70 to the central controller 630 or the display controller 610.

Referring to FIG. 12, when the weight 72 receives a force downward of the body 10 in the hole 71 to be in a corresponding position, the body 10 is determined to be in a normal orientation/position (where the user can normally view an image of the display portion 30), thus the image displayed on the display portion 30 is normally displayed. However, as shown in FIG. 13, when the weight 72 receives a force upward of the body 10 in the hole 71 to be in a corresponding position, the image displayed on the display portion 30 is rotated 180 degrees compared to that displayed in FIG. 12. This may, for example, correspond to a case in which the user wears the smartwatch in a reverse orientation/direction or a case in which the user shows his smartwatch to others even if the user normally wears it. Even if the screen is rotated, the user or the others may view the normal image because the body 10 is turned upside down when viewed by others.

Referring to FIG. 14, when the weight 72 is in a position where a force outward of the body 10 is applied, the screen of the display portion 30 may be operated such that it is powered off. This may be, for example, a state in which the user let his arm wearing the smartwatch loose downward, and in this case, the screen does not need to be powered on because the user cannot see the smartwatch.

The gravity sensor 70 may include a means for detecting the position of the weight 72 inside the hole 71. For example, the weight 72 of the gravity sensor 70 may be connected to a variable resistor (not shown). In this case, a position of the body 10 may be identified using a change in resistance according to the position of the weight 72. The gravity sensor 70 is configured such that the weight 72 moves over a rotating plate (not shown), and may generate an output signal according to the position of the weight 72 over the rotating plate. In addition, the gravity sensor 70 may be designed according to various methods known to those skilled in the art.

While embodiments have been described, it is to be understood that the invention is not limited to the described embodiments. Embodiments are intended to cover various modifications and equivalent arrangements applicable within the spirit and scope of the appended claims.

What is claimed is:

1. A watch comprising:
a display;
a bezel positioned at a periphery of the display and comprising a bezel touch sensor set, wherein the bezel touch sensor set is configured to receive a first touch without moving with respect to any other part of the bezel and is configured to generate first touch information in response to the first touch; and
a controller electrically connected to each of the bezel touch sensor set and the display and configured to use the first touch information to generate a first control signal for controlling the display.

2. The watch of claim 1, wherein the first touch information comprises at least one of touch sensor identification information and touch position information.

3. The watch of claim 1 comprising: a band connected to the bezel and configured for joining the bezel to a user of watch, wherein the first touch is received through a surface of the bezel, and wherein the band crosses or directly contacts the surface of the bezel.

4. The watch of claim 1, wherein the first touch is a sliding touch performed along a surface of the bezel for a distance.

5. The watch of claim 4, wherein the sliding touch has a nonlinear path.

6. The watch of claim 1,
wherein the bezel touch sensor set comprises a plurality of touch sensors,
wherein a first touch sensor of the touch sensors is configured to be activated by at least one of a first condition, a second condition, a third condition, and a fourth condition,
wherein the first condition comprises that any two touch sensors of the touch sensors receive separate touches for a predetermined time length,
wherein the second condition comprises that two predetermined touch sensors of the touch sensors receive respective touches for a predetermined time duration,
wherein the third condition comprises that a touch sensor of the touch sensors receives two touches within a predetermined time period, and
wherein the fourth condition comprises that a button positioned at the bezel is pressed.

7. The watch of claim 1, wherein the bezel touch sensor set comprises a plurality of touch sensors, and wherein the touch sensors are distributed between two nonlinear boundaries of the bezel in a plan view of the bezel.

8. The watch of claim 1, wherein the display is configured to display a first image when the bezel touch sensor set receives a counterclockwise touch, and wherein the display is configured to display a second image when the bezel touch sensor set receives a clockwise touch.

9. The watch of claim 1, wherein the bezel touch sensor set comprises a first touch sensor and a second touch sensor, and wherein the second touch sensor is positioned closer to a screen of the display than the first touch sensor.

10. The watch of claim 1, wherein the bezel touch sensor set comprises a plurality of touch sensors, and wherein the touch sensors are distributed in a direction that is perpendicular to a screen of the display.

11. The watch of claim 1, wherein the display is configured to display a first image when the bezel touch sensor set receives a slide touch toward a screen of the display, and wherein the display is configured to display a second image when the bezel touch sensor set receives a continuous touch away from the screen of the display.

12. The watch of claim 1, wherein the bezel touch sensor set comprises a plurality of touch sensors, and wherein the touch sensors surround the display in a plan view of a combination of the bezel and the display.

13. The watch of claim 1, wherein the bezel touch sensor set comprises a plurality of touch sensors, and wherein two geometric lines that respectively connect two immediately neighboring touch sensors of the touch sensors to a center of the display form a 30-degree angle in a plan view of a combination of the bezel and the display.

14. The watch of claim 1, wherein the bezel touch sensor set comprises a plurality of touch sensors, and wherein geometric lines that connect opposite touch sensors of the touch sensors overlap diameters of the display in a plan view of a combination of the bezel and the display.

15. The watch of claim 1, wherein the bezel touch sensor set comprises twelve touch sensors that respectively correspond to twelve hours.

16. The watch of claim 1, wherein the bezel touch sensor set comprises a first touch sensor and a second touch sensor, wherein the display comprises a display touch sensor set, wherein the first touch sensor is mapped to a predetermined hour among twelve hours, wherein the display is configured to display schedule information associated with the predetermined hour in response to a schedule display condition, and wherein the schedule display condition comprises that the first touch sensor receives an end touch after at least one of the second touch sensor and the display touch sensor set have received a start touch.

17. The watch of claim 1, wherein the bezel touch sensor set comprises a plurality of touch sensors, wherein a geometric line that connects two touch sensors of the touch sensors is configured to be a reference line, and wherein the display is configured to display images according to movement directions of slide touches received by one or more of the touch sensors with reference to the reference line.

18. The watch of claim 1 comprising: a gravity sensor connected to the controller and configured to provide orientation information based on an orientation of the display, wherein the controller is configured to use the orientation information to generate a second control signal for controlling the display to turn off or to turn on.

19. The watch of claim 18, wherein the gravity sensor is positioned inside the bezel.

20. A watch comprising:
a display;
a bezel positioned at a periphery of the display and comprising a bezel touch sensor set, wherein the bezel touch sensor set is configured to receive a first touch and is configured to generate first touch information in response to the first touch, wherein the first touch information comprises at least one of touch sensor identification information and touch position information; and
a controller electrically connected to each of the bezel touch sensor set and the display and configured to use the first touch information to generate a first control signal for controlling the display to display a first image.
